(19) United States
(12) Patent Application Publication
(10) Pub. No.: US 2019/0010898 A1
(43) Pub. Date: Jan. 10, 2019

(54) ENGINE WITH EXTENDED LONG ROUTE EGR OPERATIONS

(71) Applicant: GM Global Technology Operations LLC, Detroit, MI (US)

(72) Inventors: Alberto RACCA, Cavallermaggiore (IT); Luca BUZZI, San Secondo di Pinerolo (IT); Cesare Maria MEANO, Torino (IT); Riccardo BARIA, Bruino (IT)

(21) Appl. No.: 15/645,325

(22) Filed: Jul. 10, 2017

(51) Int. Cl. F02M 26/30; F02M 26/06; F02M 26/73; F04D 29/58; F04D 29/42

(52) U.S. Cl. CPC F02M 26/30; F02M 26/06; F04D 29/4206; F04D 29/582; F02M 26/73

(57) ABSTRACT

An internal combustion engine, including an engine structure having a plurality of cylinders. An air intake system is in communication with the plurality of cylinders. An exhaust system is in communication with the plurality of cylinders. A turbocharger has a turbine section in communication with the exhaust system and a compressor section in communication with the air intake system and including a compressor housing having a cooling jacket. An EGR passage is in communication with the exhaust system and the air intake system. The EGR passage includes a cooled EGR valve.

### FIELD

The present disclosure relates to an engine with a long route exhaust gas recirculation arrangement for extended long route EGR operations.

### BACKGROUND AND SUMMARY

This section provides background information related to the present disclosure which is not necessarily prior art.

If the coolant temperature in the cooler of a long route EGR system falls below the dewpoint, condensation can happen, which can compromise the compressor wheel integrity. Current long route EGR recirculation at low engine coolant temperatures is limited by condensation avoidance strategies aimed at preserving the compressor durability. Such limitations involve operative conditions at low engine coolant temperature and low ambient temperature. Moreover, difficulties in long route EGR recirculation at low engine speed and load may be encountered because of the pressure drop along the long route circuit.

Present disclosure provides a modified long route EGR system and turbocharger in order to overcome the previous restrictions. The system provides for removal of the conventional long route EGR cooler and provides a cooling system on the long route EGR valve. The system also provides for a cooling jacket on the compressor scroll and backplate and replaces standard compressor wheel material with high temperature resistant materials.

According to the present disclosure, an internal combustion engine includes an engine structure including a plurality of cylinders. An air intake system is in communication with the plurality of cylinders. An exhaust system is in communication with the plurality of cylinders. A turbocharger has a turbine section in communication with the exhaust system and a compressor section in communication with the air intake system and including a compressor housing having a cooling jacket. The compressor's backplate may be provided with a cooling jacket as well. An EGR passage is in communication with the exhaust system and the air intake system. The EGR passage includes a cooled EGR valve.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The FIGURE is a schematic view of an internal combustion engine having a long route EGR system according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not to be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the FIGURES. Spatially relative terms may be intended to encompass different orientations of the device in use or operation in addition to the orientation depicted in the FIGURES. For example, if the device in the FIGURES is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

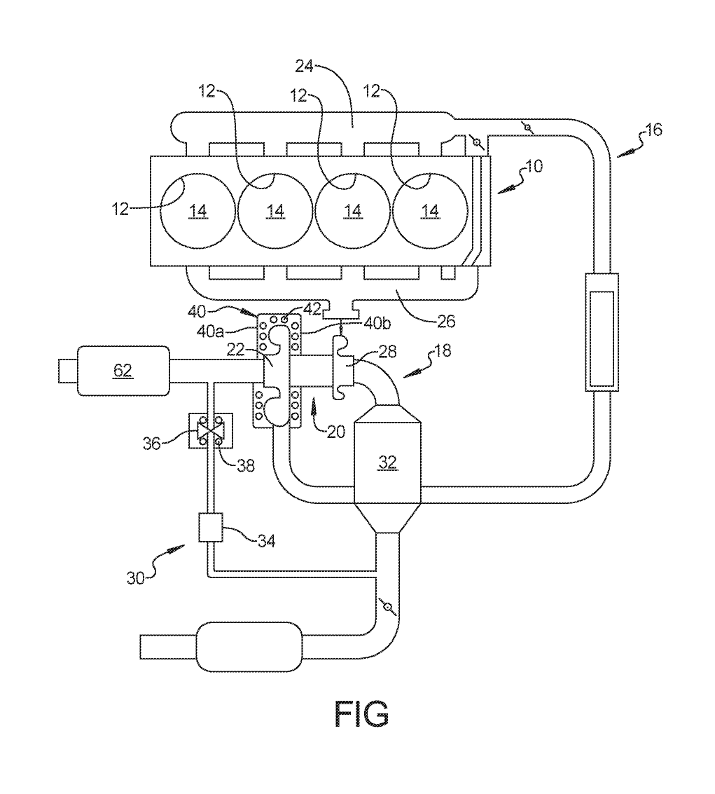

With reference to FIG. 1, an internal combustion engine 10 is shown including a plurality of cylinders 12 each having a working piston 14 disposed therein. The internal combustion engine 10 has an intake system 16 and an exhaust system 18. The intake system 16 can be provided with a turbocharger 20 having a compressor wheel 22 for providing compressed intake air to an intake manifold 24 which is connected to the cylinders 12. The exhaust system 18 includes an exhaust manifold 26 which directs exhaust gasses to a turbine wheel 28 of the turbocharger 20 (if present).

An exhaust gas recirculation (EGR) system 30 is connected between an aftertreatment system 32 of the exhaust system 18 and the intake system 16. The EGR system 30 includes an EGR filter 34 and a cooled long route EGR valve 36.

The cooled long route EGR valve 36 includes coolant passages 38 therein. In addition, the compressor section 40 of the turbocharger 20 is provided with a cooling jacket 42 on the compressor's scroll 40a and backplate 40b. In addition, the compressor wheel 22 is made from a high temperature resistant material such as, for example TiAl as opposed to aluminum alloys. The turbine wheel 28 can also be made from a lower density material, e.g. TiAl in order to compensate for the potential compressor wheel 22 inertia increase due to the application of high-temperature resistant materials.

By eliminating the conventional EGR cooler, the present disclosure reduces condensation issues at low engine coolant temperature conditions, because EGR gases do not encounter a cold cooler matrix. Therefore, the long route EGR recirculation strategy is decoupled from engine coolant temperature resulting in higher flexibility in EGR management, potentially extendable to any engine coolant temperature. The hotter EGR gases reaching the long route EGR connection in front of the compressor reduces the risk of condensation generation potentially generated by mixing with cold inlet air thanks to the higher thermal energy content of hotter exhaust gas recirculation. The removal of the EGR cooler allows for a more compact long route EGR circuit with reduced pressure drops enabling improved long route EGR response in transient conditions and at low engine speeds/loads.

The cooling of the long route EGR valve 36 helps to protect the valve electronics from high EGR gas temperatures.

The water cooled jackets in the compressor scroll 40a and/or back plate 40b effectively maintain a constant metal temperature in the compressor housing and back plate regardless of the temperature of the gases inside the compressor. The water-cooled jackets avoid any potential oil coking formation on the compressor inner walls due to higher temperatures reached by gases during the compression phase because of the removal of the EGR cooler.

The removal of the EGR cooler results in the introduction of EGR gases exceeding current temperature limitations for standard materials applied to compressor wheels (e.g. Aluminum alloys). Accordingly, the use of high temperature resistant materials, such as TiAl, for the compressor wheel preserves rotor durability and limits fatigue that otherwise would be experienced by standard materials such as Aluminum alloys. Low density materials, such as TiAl, minimize the inertia increase that would induce transient performance penalties.

A lower-density material (e.g. TiAl or other lower density material) would also be preferable for the turbine wheel 28 in order to compensate the potential compressor inertia increase due to the implementation of high temperature resistant materials.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An engine system, comprising:
an internal combustion engine including a plurality of cylinders;
an air intake system in communication with the plurality of cylinders;
an exhaust system in communication with the plurality of cylinders;
a turbocharger having a turbine section in communication with the exhaust system and a compressor section in communication with the air intake system and including a compressor housing having a cooling jacket including coolant passages in the compressor scroll and the compressor backplate;
a long route EGR passage in communication with the exhaust system downstream from the turbine section of the turbocharger and with the air intake system upstream of the compressor section of the turbocharger, said long route EGR passage including a cooled EGR valve exterior to the internal combustion engine and having coolant passages therein, wherein the long route EGR passage is free from an EGR cooler.

2. The engine system according to claim 1, wherein said compressor section includes a compressor wheel made from low density, high temperature resistant material.

3. The engine system according to claim 2, wherein said low density, high temperature resistant material includes TiAl.

4. The engine system according to claim 1, wherein said turbine section includes a turbine wheel made from low density, high temperature resistant material.

5. The engine system according to claim 4, wherein said low density, high temperature resistant material includes TiAl.

6-9. (canceled)
